(19) United States
(12) Patent Application Publication
(10) Pub. No.: US 2020/0018282 A1
(43) Pub. Date: Jan. 16, 2020

(54) A CLOSED CYCLE HYDROELECTRIC PLANT WITH AIR HYDRAULICS CENTRIFUGE JET TURBINE

(71) Applicant: Ismail KARTO, Istanbul (TR)

(72) Inventor: Ismail KARTO, Istanbul (TR)

(21) Appl. No.: 16/490,701

(22) PCT Filed: Nov. 24, 2017
(86) PCT No.: PCT/TR2017/050596

§ 371 Date: Sep. 3, 2019

(30) Foreign Application Priority Data
Mar. 8, 2017 (TR) 2017/03576

(51) Int. Cl. F03B 17/00

(52) U.S. Cl. CPC F03B 17/005

(57) ABSTRACT

A hydroelectric plant has concentric inner and outer pipes, an air flow channel allowing air flow between these pipes, and floodgate pipes with water flow channels where the water flow is allowed through the inner pipe, an air supply block with a multitude of air inlet vents-which supply air to the mentioned air flow channel and a multitude of water impact paddles upon which the water flowing out of the floodgate pipes via the air supply is impacted.

### TECHNICAL FIELD

The invention relates to a hydroelectric plant with jet turbine effect, which utilizes the water stored in its reservoir by means of a closed cycle system, without causing damage to ecological structures and environmental factors, suitable for installation at villages and cities, in addition to being used on board ships and trains and on various other vehicles.

### PRIOR ART

Patent application no. WO2015174938A1 dated May 14, 2014 by Ismail KARTO relates to a hydroelectric plant with jet turbine effect. In this patent application; a hydraulic jet centrifuge-reactive turbine intended to be used to generate electrical energy, where water flows in through a water inlet opening and propagates through a water flow path and a water inlet body. The mentioned water inlet opening and water flow path. A multitude of evacuation cavities, which are introduced on the water flow path and where the water is delivered via the mentioned water inlet opening and water flow path, comprises a multitude of evacuation pipes which are connected with the mentioned evacuation cavities in order to enable evacuation the water to the outside environment and provide the rotational motion of the turbine. Moreover, it also comprises a moveable group introduced at the end of each evacuation pipe in order to provide rotational motion by means of twisted jet elbows and enabling the water to flow out of the mentioned twisted jet elbows.

Patent no WO2015174938A1 is related to a structure with essential technical flaws and to a low efficiency system. For example, the bearings of the movable group cannot provide an efficient bearing. Therefore, a strong jet effect cannot be achieved due to the spreading water while flows out through the mentioned jet elbows.

Another example of the prior art is given by the Chinese patent application no CN201827005. In this application, rotational motion of a main block is realized by a main block to which the water is directed and the output water through water outlet arms seated on this main block. However, this system too does not possess the desired efficiency and cannot operate at the desired high capacity. Because an efficient design have not been provided due to the length of the water outlet arms and the system geometry.

Another example is given by the Japanese patent application no 56050268 owned by KIYOTATSU. Similar to the current structures of the prior art, this application also comprises a main water block and water outlet pipes with rotational structures, to which the water is directed via this block and which provides the drive by performing rotational motion. On the other hand, this structure fails to deliver an efficient and stable energy output. Generators of the prior art have the necessity of being located in an area with a stream, river or a running water source is present. This is because the arm structures through which the water flows out and which delivers the primary drive fail to provide a suitable geometric structure and technical equipment in order to deliver an efficient drive.

### DESCRIPTION OF THE INVENTION

Object of the invention is to provide a hydroelectric plant with jet turbine effect in order to provide a high driving capacity with improved efficiency with respect to systems of the prior art.

Object of the invention is provide a structure with close cycle operation without requiring a river, water stream or a running water source, using the stored water in its reservoir.

An object of the invention is to provide air supply systems introduced at the end of water outlet pipes in order to prevent spreading of the water, in contrast with the water outlet pipes of the prior art. The water can be impacted to the opposite surface without spreading by using the air supply system. Therefore, additional rotational motion is delivered to the pipes due to the high pushing force.

Another object of the invention is to provide a structure with a rigid bearing and with decreased number of bearing elements in areas where the rotational motion is realized, in contrast to the application WO2015174938A1.

Another object of the invention is to provide air via the already rotating system without requiring an external air supply tank and to deliver this air continuously to the edges of the water outlet openings.

### DRAWINGS THAT WILL HELP UNDERSTANDING THE INVENTION

FIG. 1; Gives a general perspective view of the entire hydroelectric plant of the invention.

FIG. 2; Gives a general cross-sectional perspective view of the entire hydroelectric plant of the invention.

FIG. 3; Gives a perspective view of the core area where the energy is generated and the drive is produced.

FIG. 4; Gives a two-dimensional close-up view of a cross-section of the core area where the energy is generated and the drive is produced.

FIG. 5; Gives a general cross-sectional perspective view of the core area where the energy is generated and the drive is produced.

FIG. 6; Gives a general perspective cross-sectional view of the core area with side cover elements.

FIG. 7; Gives a general perspective view of the core area with upper cover elements.

FIG. 8; Gives a top perspective view where upper cover elements are removed and the paddles are visible.

FIG. 9; Gives a general close-up view of the support profile structures.

FIG. 10; Gives a two-dimensional close-up view of a cross-section of the pipes with air supply, from which the water flows out.

FIG. 11; Gives a close-up view of the inner air curtains which block the air circulation.

FIG. 12; Gives a close-up view of individual paddles.

FIG. 13; Gives a close-up perspective view of the paddles, upon which the water emerging from the pipes impacts.

### PARTS LIST

100-Hydroelectric plant
101-Main Platform
102-Main inlet block
103-Water reservoir
104-Inlet opening
105-Stairs
106-Balcony
107-Water transfer pipe
108-Circulation pipe
109-Pump
110-Fastening arm
111-Balcony rail
112-Pipe fastening arms
113-First receiving chamber
200-Turbine
201-Water inlet
202-Water inlet block
203-Seal
204-Bearing element
205-Rotating block
206-Connection element
207-Outer cover block
2071-Lower base
2072-Lateral peripheral wall
2073-Water transfer gaps
208-Pipe flange
209-Support legs
210-Pipe bearing opening
211-Water outlet opening
212-Lower table
213-Water-breaking pillar
214-Lower seal
215-Lower bearing block
216-Lower block fastening lug
217-Lower block fastener
218-Block valves
219-Lower support plate
220-Driveshaft
221-Shaft space
222-Lower connection components
223-Water partition flap
224-Air supply block
2241-Upper boundary
2242-Side boundary
225-Air storage space
226-Partitions
227-Air inlet vent
228-Lower support framework
229-Middle support platform
230-Support extensions
231-Vibration wedge
232-Lower support profiles
233-Support posts
234-Generator
235-Drivetrain element
236-Gear reducer
237-Auxiliary gear reducer
238-Main drive element
239-Support construction
240-Air curtain (purpose of
air curtains)
241-Upper jaw
242-Lower jaw
243-Legs
244-Fasteners
245-Mounting bracket
246-Upper mounting plate
250-Water impact paddles
251-Mounting profile
252-Mounting lug
253-Mounting screw
254-Partition surface
255-Oval cavity
260-Floodgate pipes
261-Elbow pipe
262-Reduced outlet
263-Outer pipe
264-Inner pipe
265-Air flow channel
2651-Air inlet opening
266-Support bearings
267-Water flow channel
268-Connection flanges
269-Water outlet opening
270-Control panel

### DETAILED DESCRIPTION OF THE INVENTION

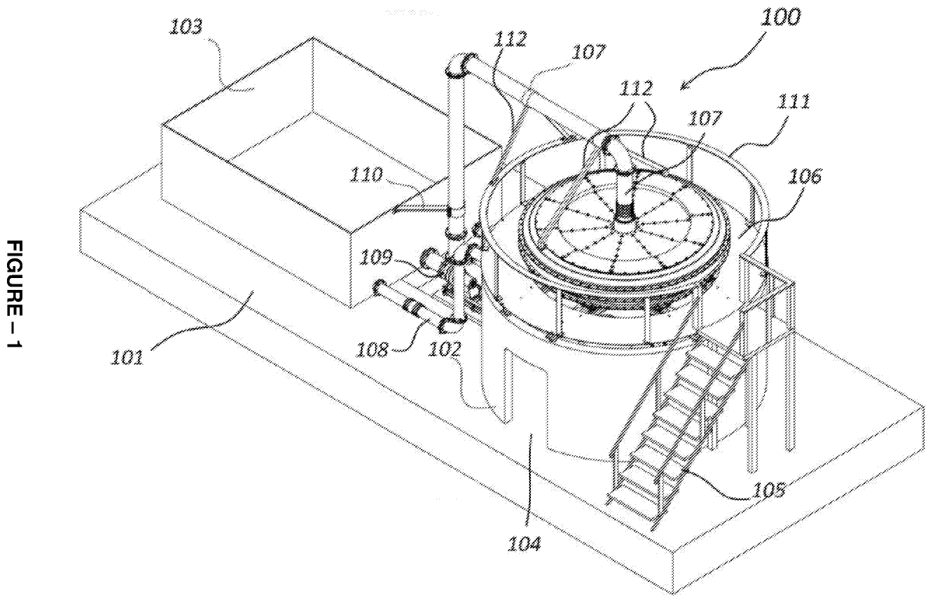

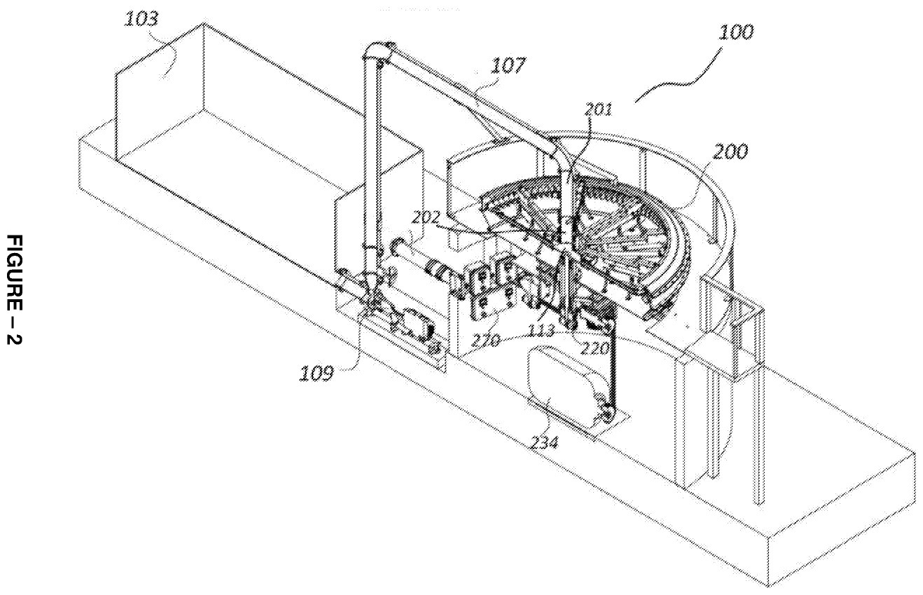

FIGS. 1 and 2 depict a hydroelectric plant (100), comprising a water inlet block (202) to which the water from a natural water supply or an available water reservoir (103) is transferred through a water inlet (201) opening, a first receiving chamber (113) to which the water is transferred through the water inlet block (202), a multitude of floodgate pipes (260) having water outlet openings to which the water is transferred through the first receiving chamber (113), a rotating block (205) performs a rotating motion as the water flows out through the water outlet openings (269), a driveshaft (220) delivers the motion provided by the rotating block (205) to the generator (234) and a turbine (200) controlled via a control panel (270).

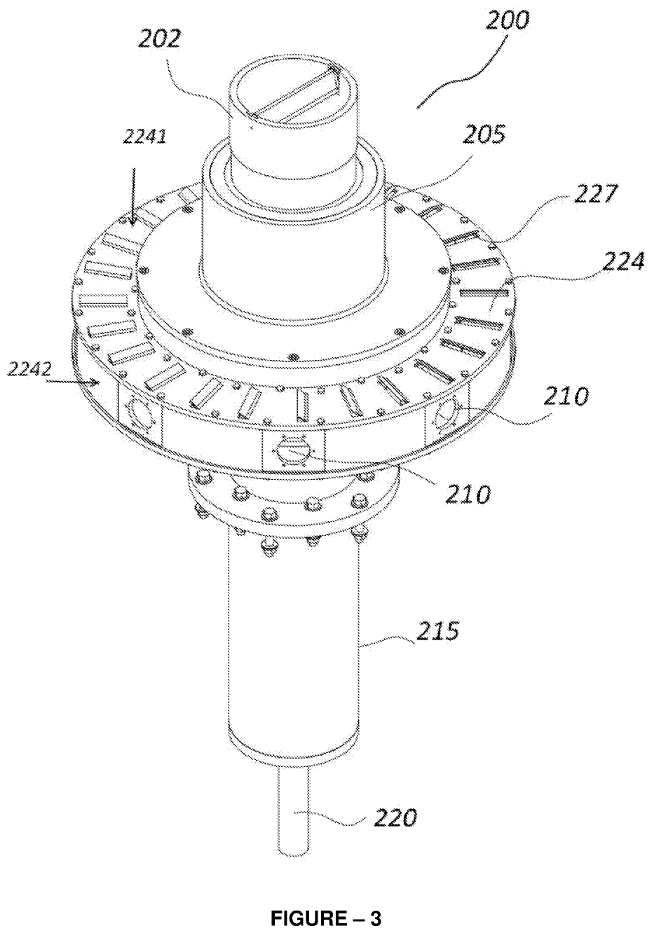

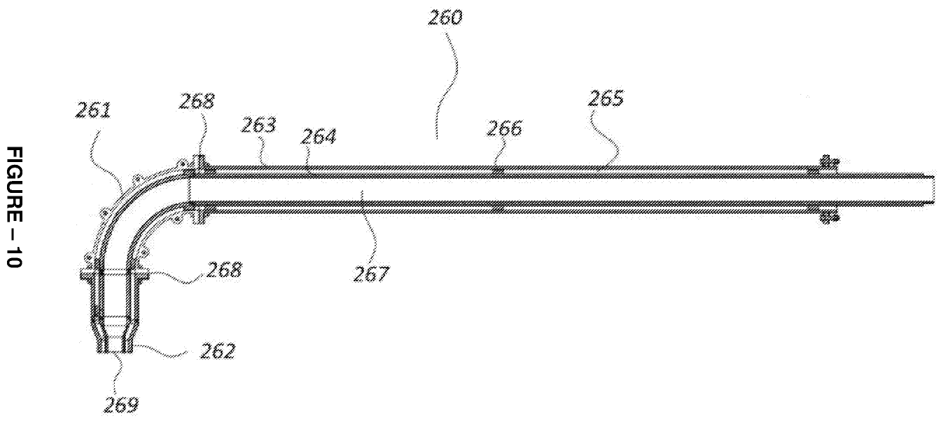

The hydroelectric plant (100) substantially comprises; an inner pipe (264); an outer pipe (263); an air flow channel (265) allowing air flow between these pipes (263, 264) and floodgate pipes (260) with water flow channels (267) where the water flow is allowed through the inner pipe (264) (See FIG. 10). Likewise, it comprises an air supply block (224) with a multitude of air inlet vents (227) supply air to the mentioned air flow channel (265) as a result of its rotational motion (See FIG. 3). In addition, it comprises a multitude of water impact paddles (250) upon which the water flowing out of the floodgate pipes (260) by means of the air supply is impacted and a multitude of air curtains (240) which enclose the mentioned floodgate pipes (260) on lower and upper regions and blocks the air circulation generated inside.

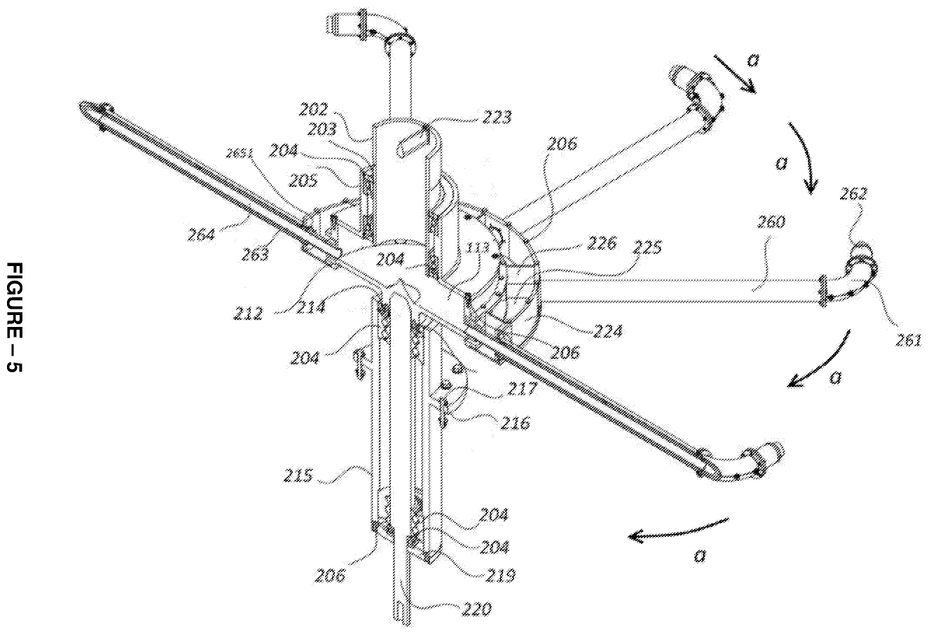

On the other hand, it comprises support bearings (266) seated between an outer pipe (263) and an inner pipe (264), and connection flanges (268) connect an elbow pipe (261) with a reduced outlet (262) and the outer pipe (263). FIGS. 3 and 5 depict an air supply block (224) comprising an air storage space (225) with partitions (226), introduced on the rotating block (205) and rotates along with the rotating block (205).

The air supply block (224) also comprises a multitude of air inlet vents (227) introduced on its upper boundary (2241) and a multitude of pipe bearing openings (210) introduced on its side boundary (2242).

Water impact paddles (250) depicted in FIG. 12 comprises; a blade edge shaped partition surface (254) introduced on the oval cavity (255) which has a dome shaped outer surface and oval carved inner surface; and a mounting profile (251), a mounting lug (252) and a mounting screw (253) to fix the water impact paddles (250) to outer cover block (207).

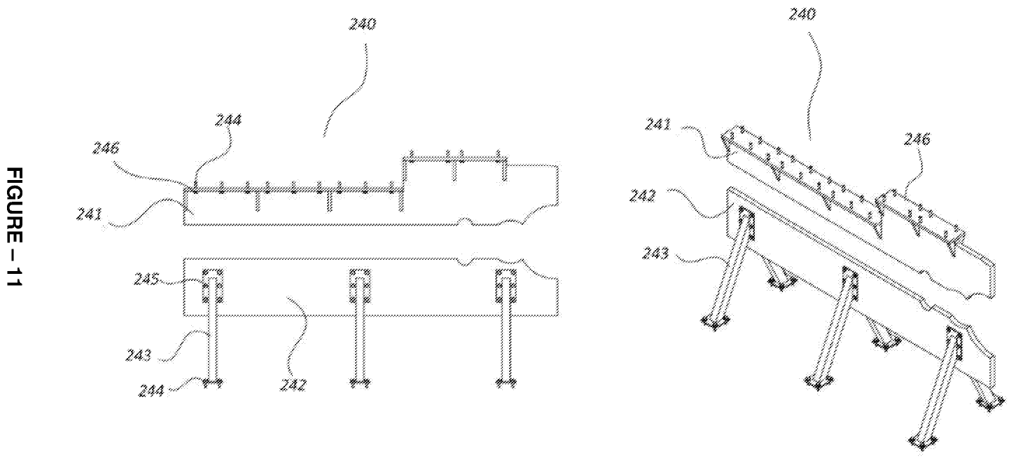

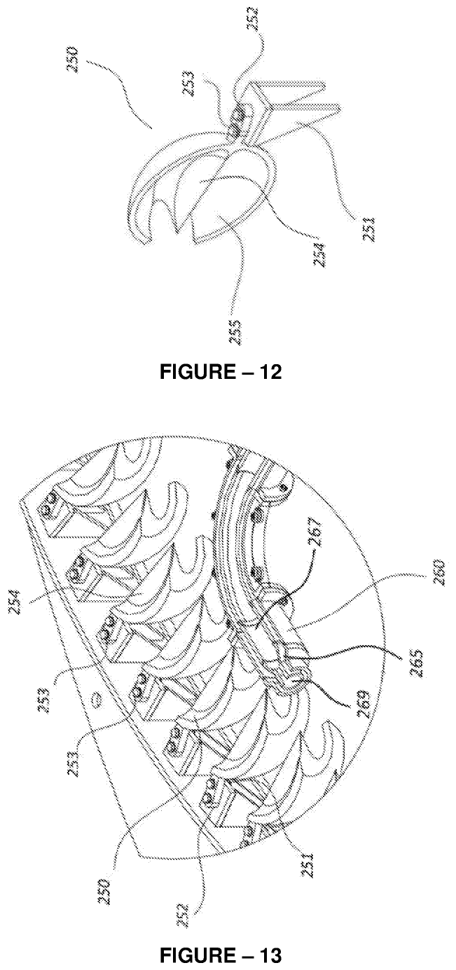

The air curtains (240) depicted in FIG. 11 comprises an upper jaw (241) and a lower jaw (242) in between which the floodgate pipes (260) are introduced. Likewise, it comprises legs (243), mounting bracket (245) and fasteners (244), all of which fix the lower jaw (242) to the base surface of the outer cover block (207), and an upper mounting plate (246) fastens the upper jaw (241) to cover block (207) and has vertically arranged fasteners (244) on it.

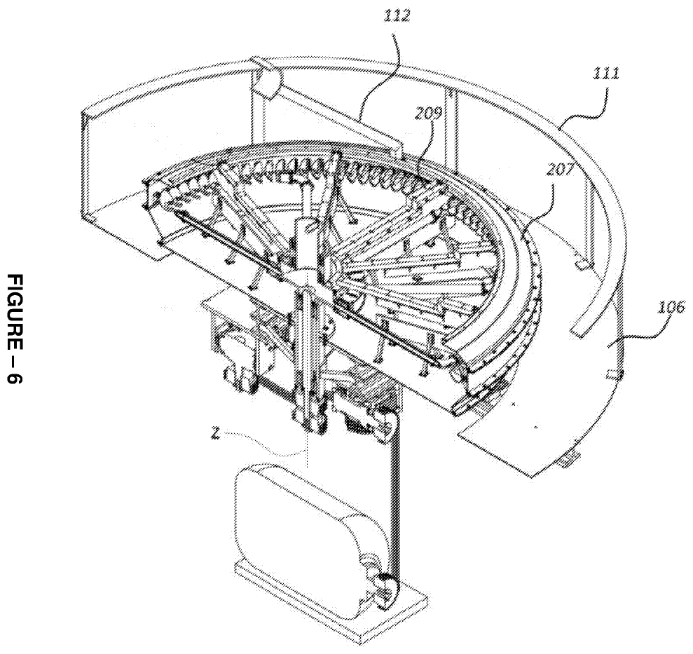

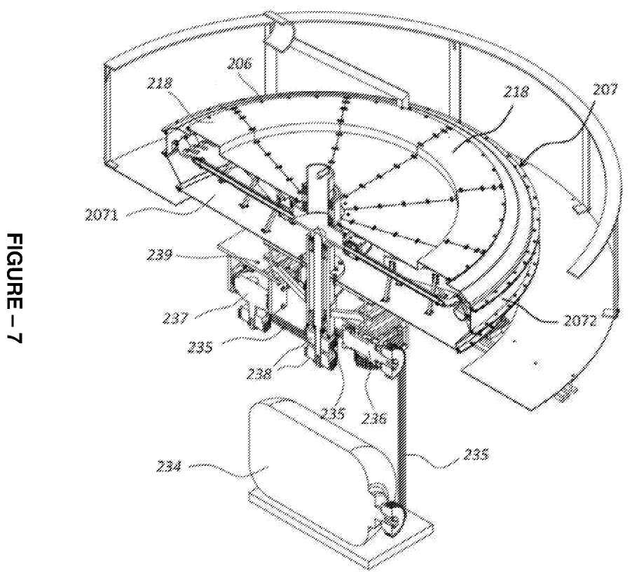

FIGS. 6 and 7 depict an outer cover block (207) comprising a lateral peripheral wall (2072) which encloses the mentioned turbine (200) and the floodgate pipes (260) from the outside boundary, a lower base (2071) which encloses from the lower boundary, and multiple triangle shaped block valves (218) which enclose them from the upper side.

FIG. 1 depicts the main platform (101) which allows access to the outer cover block (207), introduced around the turbine (200) and comprises a balcony (106), inlet opening (104), stairs (105), balcony rails (111), pipe fastening arms (112) and main inlet block (102). A water transfer pipe (107) which allows water to be delivered to this water inlet (201) via the mentioned water reservoir (103) and pump (109), and a circulation pipe (108) which is integrated with the system and allows the water inside the mentioned turbine (200) to be returned to the water reservoir (103).

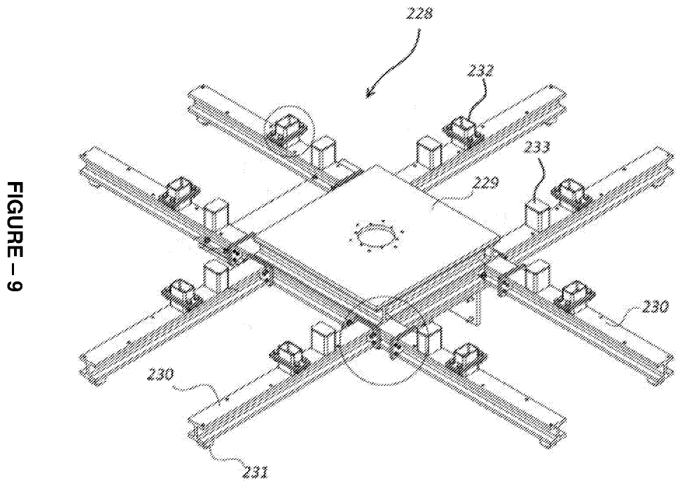

FIG. 9 depicts a lower support framework (228). This structure comprises a middle support platform (229) which is introduced below the outer cover block (207) and the balcony (106) and supports the load of the turbine (200), a multitude of support extensions (230) extending along different directions with respect to each other, lower vibration wedge (231), lower support profiles (232) and a multitude of support pillars (233).

FIG. 7 depicts at least one main drive element (238) supported with a driveshaft (220) along the vertical z-axis, and which delivers the motion of the driveshaft (220) to the generator (234). On the other hand, at least one gear reducer (236) and an auxiliary gear reducer (237), to which the motion of the mentioned main drive element (238) is delivered by means of drivetrain elements (235), are integrated to the system. Furthermore, it comprises a support construction (239) to which the mentioned gear reducer (236) and the auxiliary gear reducer (237) are fixed.

### Operation of the Turbine (200) of the Invention is Described Below.

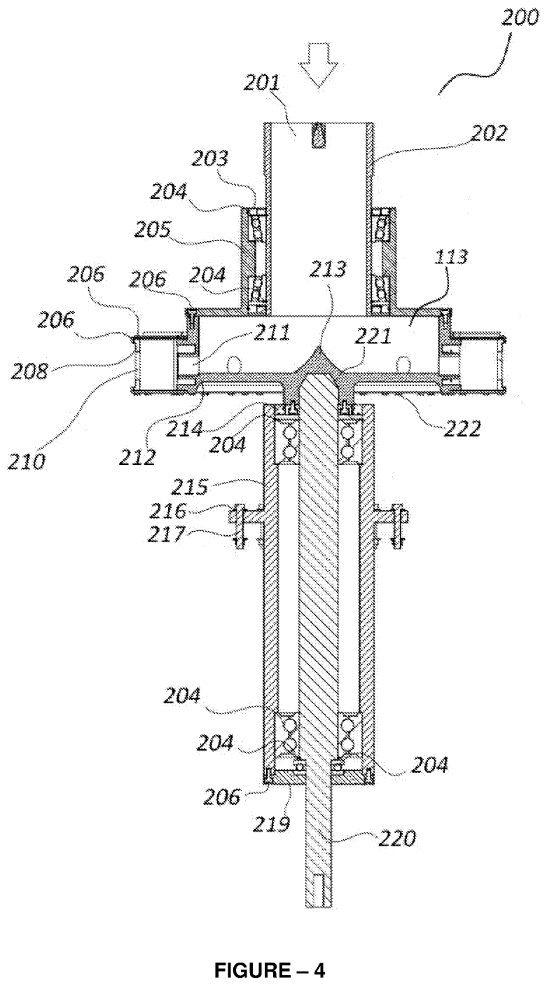

Water supplied from a natural source or an available water reservoir (103) is fed to the water inlet block (202) through the water inlet (201) opening. Water is delivered by means of the pump (109) and the water transfer pipe (107). Water flowing into the water inlet block (202) fills the receiving chamber (113). The water-breaking pillar (213) splits the body of water inside the receiving chamber (113). While the water is filling this area, it is also delivered to the inner pipe (264) via the water outlet opening (211). Water delivered into the inner pipe (264) flows to the reduced outlet (262) to flow out (See FIGS. 4 and 5). When the water directed inside the inner pipe (264) flows out of the reduced outlet (262), it pushes floodgate pipes (260) in the a-direction due to jet effect. Water flowing out of the reduced outlet (262) provides the desired rotational motion by rotating all floodgate pipes (260) in the a-direction with jet effect.

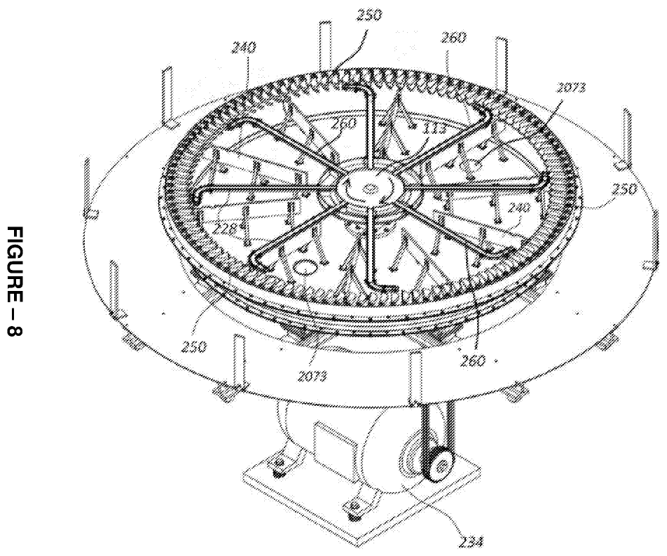

In order to enhance this rotating effect and obtain an increased jet effect, water impact paddles (250) are introduced directly opposite to the water outlet openings (269) (see FIGS. 8 and 12). A multitude of water impact paddles (250) are fixed about the rotating block (205), inside the outer cover block (207). Thrust is substantially increased by the impact of the water upon the water impact paddles (250). On the other hand, delivery with air supply is provided in order to prevent the water sprayed from the water outlet openings (269) to spread and to ensure a rigid exit and impact without spreading. By means of the air flow channel (265), water flowing out through water outlet openings (269) is impacted upon the oval cavity (255) surface in a rigid manner, without spreading. Water moves inside the protective air and impacts upon the partition surface (254) together with the air. Therefore, a stronger and more effective impact is obtained. Air supply required by water flow channels (267) is supplied by means of the air supply block (224). Since the air supply block (224) is already in connection with the rotating block (205) and rotates along with it, air supply is obtained by means of the air inlet vents (227) and the air rushing into these vents due to this rotational motion. Obtained air is continuously directed towards water flow channels (267) (see FIG. 3).

As a result of the rotation of the floodgate pipes (260) based on the aforementioned system, a rotational motion is obtained and this cycle continues uninterrupted with the water supply fed continuously into the rotating block (205). Since floodgate pipes (260) which generate the rotating motion, along with the rotating block (205), the lower bearing block (215) and the driveshaft (220) are fixed and centered, these structures perform a rotational motion all together. Since the driveshaft (220) has bearing of the rotating block (205) and fixed by the floodgate pipes (260), the driveshaft (220) is able to deliver this rotational motion to the drive element (238), drivetrain elements (235) and gear reducers (236). Auxiliary gear reducer (237) can be activated on demand.

The hydroelectric plant (100) has closed cycle operation. Water inside the water reservoir (103) is fed into the turbine (200) and after flowing out through the floodgate pipes (260), accumulates on the lower base (2071) of the outer cover block (207), and it returns back into the water reservoir (103) via water transfer gaps (2073) (see FIG. 8) and circulation pipe (108). This cycle repeats uninterruptedly.

FIG. 4 shows rotating and FIG. 5 depict rotating and stationary parts completely. The water inlet block (202), through which the water flows in initially, is stationary. The rotating block (205) starts to rotate once the water flows out through the floodgate pipes (260). Sealing (203) and bearing elements (204) are introduced in the bearing area between the rotating block (205) and the water inlet block (202). By means of the bearing elements (204), the rotating block (205) and the air supply block (224) integrated with the rotating block (205) starts rotating. When this volume is receiving water from the pump (109), it should operate with sufficient speed and at an adequate level. In other words, if the pump (109) delivers 100 liters water in one second, then the volume of the first receiving chamber (113) shall not be less than 100 liters. The proper value is approximately 100×ϕ, wherein ϕ is “the golden ratio”. Furthermore, a vibration dampening water partition flap (223) fixed on to inner boundary surface of the water inlet block (202) is depicted in FIG. 5.

Likewise, the floodgate pipes (260) fixed onto the air supply block (224) also performs rotational motion. Due to the rotating lower table (212) and since the driveshaft (220) is fixed to the shaft space (221), which is introduced on a lower region of this lower table (212), by means of shrink-fit, the driveshaft (220) is also imposed upon by this drive and by performs rotational motion, delivers its motion to the generator (234). The driveshaft (220) is centered with the bearing block (215) and bearing elements (204). On the other hand, bearing block (215) is stationary. Similarly, the bearing block (215) is fixed to lower base (2071) of the outer cover block (207) by means of the lower block fixing lug (216). In this case, outer cover block (207) is also a stationary part, to which not drive force is delivered. Another stationary part is the water impact spoon (250). While the floodgate pipes (260) are performing rotational motion, the also hit the stationary water impact paddles (250) with water. The water impact paddles (250) are fixed to the inner surfaces of the stationary outer cover block (207) by means of mounting elements. Another stationary element is the air curtain (240), which is fixed on the lower base (2071) of the outer cover block (207). With their stationary structure, air curtains (240) allow the floodgate pipes (260) to rotate between the upper jaw (241) and the lower jaw (242) and block the air circulation created by this rotational motion. On the other hand, air supply block (224) is moving rotationally. Because rotational motion of the air supply block (224) is desired. This is due to the existence of air inlet vents (227) introduced on the air supply block (224), with their flaps directed towards the direction of rotation. Due to the rotational motion of the air supply block (224), air flows into the air inlet vents (227) and transferred to the air storage space (225), and then air is filled into the air flow channel (265) via the air flow opening (2651).

Air curtains (240) are depicted in FIG. 11. The air curtains (240) cover the floodgate pipes (260) from above and from below by means of the upper jaw (241) and the lower jaw (242). Since the floodgate pipes (260) are introduced between of the upper jaw (241) and the lower jaw (242), where it performs a rotational motion, they block the air circulation created by the rotational motion of the floodgate pipes (260).

When the length of floodgate pipes (260) are below 1.5 meters, the elbow pipe (261) should be manufactured with the angle between the inlet and the outlet (4°-10°) is expanded, in other words, it is 94°-100°. The expansion angle increases with the increasing length of the water flow channel (267), i.e. length of the floodgate pipes (260). The water outlet opening (269) is introduced to ensure an improved of the water jet upon the water impact paddle (250). In this case, the power shall be reduced by a factor of the design capacity determined by the cosine of a portion of the expansion angle exceeding 90°, in other words, N=Np×cos (4°-10°).

In the system, generator (234) power depends on the power selector shaft of the grid. For example, if it is 100 kW; then the power of the power plant should not be less than 162 kW (i.e. 100×φ). Volume of the water reservoir should be calculated that this volume adjusts the water delivery performance of the pump to a volume of 2-4 minutes. Power rating of the hydroelectric plant (100) should be set to 150 kW. During the laboratory phase, it has been observed that when the power of the air-hydraulic centrifuge-jet turbine effect of the hydroelectric plant (100) is less than 150 kW, then the effect is too low. In other words, the effect will be higher if a high power is chosen during project design phase.

Therefore, the parameters and values given below for the hydroelectric plant (100) are of critical importance.

1. volume of water in circulation
2. revolution rate
3. power
4. dimensions of water inlet splitting holes, i.e. pipe bearing openings (210),
5. dimension of water consumption nose
6. dimensions of water inlet block (202)
7. volume of first receiving chamber (113)
8. dimensions of water impact paddles (250)
9. water volume rate capacity of the pump (109)
10. gear reducer (236) and drivetrain elements,

1. A hydroelectric plant comprising a water inlet block to which the water from a natural water supply or an available water reservoir is transferred through a water inlet opening, a first receiving chamber to which the water is transferred through the water inlet block, a multitude of floodgate pipes having water outlet openings to which the water is transferred through the first receiving chamber, a rotating block performing a rotating motion as the water flows out through the water outlet openings, and a turbine with a driveshaft which delivers the motion provided by the rotating block to the generator, characterized by comprising:
floodgate pipes comprising concentric inner pipe and outer pipe, an air flow channel allowing air flow between these pipes and water flow channels where the water flow is allowed through the inner pipe;
an air supply block with a multitude of air inlet vents which supply air to the air flow channel;
a multitude of water impact paddles upon which the water flowing out of the floodgate pipes by means of the air supply is impacted;
a multitude of air curtains enclosing the floodgate pipes on lower and upper regions and blocking the air circulation generated inside.

2. The hydroelectric plant according to claim 1, comprising support bearings seated between the outer pipe and the inner pipe.

3. The hydroelectric plant according to claim 1, comprising connection flanges connecting the outer pipe with a reduced outlet that narrowed with an elbow pipe.

4. The hydroelectric plant according to claim 1, comprising an air supply block comprising an air storage space with partitions, introduced on the rotating block and rotates along with the rotating block.

5. The hydroelectric plant according to claim 1, comprising an air supply block comprising a multitude of air inlet vents introduced on its upper boundary and a multitude of pipe bearing openings introduced on its side boundary.

6. The hydroelectric plant according to claim 1, characterized in that the water impact paddles have a dome shaped outer surface and have an oval cavity on their inner surface.

7. The hydroelectric plant according to claim 1, characterized in that the water impact paddles comprising a blade edge shaped partition surface introduced on the oval cavity.

8. The hydroelectric plant according to claim 1, comprising a mounting profile, a mounting lug and a mounting screw fastening the water impact paddles to an outer cover block.

9. The hydroelectric plant according to claim 1, characterized in that the air curtains comprising an upper jaw and a lower jaw positioned as surrounding the floodgate pipes.

10. The hydroelectric plant according to claim 9, comprising legs, a mounting bracket and fasteners fastening the lower jaw to the base surface of the outer cover block.

11. The hydroelectric plant according to claim 9, comprising an upper mounting plate with vertically arranged fasteners fastening the upper jaw to the outer cover block.

12. The hydroelectric plant according to claim 1, characterized in that the outer cover block comprising a lateral peripheral wall which encloses the turbine and the floodgate pipes from the outside boundary, a lower base which encloses from the lower boundary, and a multitude of triangle shaped block valves which enclose them from the upper side.

13. The hydroelectric plant according to claim 12, comprising a main platform allowing access to the outer cover block and comprising a balcony, an inlet opening, stairs, balcony rails, pipe fastening arms and a main inlet block which are formed around the turbine.

14. The hydroelectric plant according to claim 1, comprising a water transfer pipe allowing water to be delivered to the water inlet via the water reservoir and a pump, and a circulation pipe ensuring the water inside the turbine to be returned to the water reservoir.

15. The hydroelectric plant according to claim 1, comprising a lower support framework comprising; a middle support platform introduced below the outer cover block and the balcony, supporting the load of the turbine; a multitude of support extensions extending along different directions with respect to each other, a lower vibration wedge, lower support profiles and a multitude of support pillars.

16. The hydroelectric plant according to claim 1, comprising at least one main drive element supported with a driveshaft along the vertical z-axis, and delivering the motion of the driveshaft to the generator.

17. The hydroelectric plant according to claim 16, comprising at least one gear reducer and an auxiliary gear reducer, to which the motion of the main drive element is delivered by means of drivetrain elements.

18. The hydroelectric plant according to claim 17, comprising a support construction to which the gear reducer and the auxiliary gear reducer are fixed.

19. The hydroelectric plant according to claim 12, comprising water transfer gaps introduced on the lower base of the outer cover block, allowing the water flowing out through the floodgate pipes, to return back into the water reservoir.

20. The hydroelectric plant according to claim 1, comprising an air flow opening to which the air flowing into the air inlet vents is transferred due to the rotational motion of the air supply block.

21. The hydroelectric plant according to claim 1, comprising a water partition flap fixed on to inner boundary surface of the water inlet block in order to prevent the vibration generated by the water.
